(19) United States
(12) Patent Application Publication
(10) Pub. No.: US 2013/0342038 A1
(43) Pub. Date: Dec. 26, 2013

(54) FASTENING DEVICE FOR AN ARMATURE LAMELLA STACK

(71) Applicant: ROBERT BOSCH GMBH, Stuttgart (DE)

(72) Inventors: Frank Kopf, Ottersweier (DE); Walter Lehnert, Baden-Baden-Varnhalt (DE); Michael Strupp, Durmersheim (DE); Dana Nicgorski, Salem, MA (US); Vincent Fix, Strasbourg (FR); Friedrich Meyer, Karlsruhe (DE)

(21) Appl. No.: 13/926,263

(22) Filed: Jun. 25, 2013

(30) Foreign Application Priority Data
Jun. 25, 2012 (DE) 10 2012 210 775.4

(51) Int. Cl. H02K 1/30; H02K 9/06

(52) U.S. Cl. CPC H02K 1/30; H02K 9/06
USPC 310/43; 310/51

(57) ABSTRACT

Fastening device (1) for an armature lamella stack (2) of a DC motor, characterized in that the fastening device (1) is disposed between the armature lamella stack (2) and a shaft (3) of the DC motor and is designed as a torsionally soft connection of said armature lamella stack (2) to the shaft (3).

### BACKGROUND OF THE INVENTION

The invention relates to a fastening device for an armature lamella stack of a DC motor. The invention further relates to a DC motor.

### TECHNICAL FIELD

Brush-commutated DC motors comprising an armature lamella stack that is rigidly fastened to a shaft are well known in the prior art. For the most part, the lamella stack is thereby conventionally pressed onto the shaft. The lamella stack and a winding are insulated from one another by means of plastic, wherein the insulation can comprise insulating masks, a plastic encapsulation or a plastic coating of the winding. Ventilation openings can be located in an inside region of the armature lamella stack.

The German patent application DE 199 33 037 A1 discloses a shaft-armature lamellae fixing for fixing armature lamellae or an armature lamella stack on a shaft. An armature lamella that encircles the shaft has at least one axial surface. An elevation which protrudes from the shaft and which is produced by plastic deformation rests on said axial surface. The elevation prevents an axial displacement and rotatory twisting.

### SUMMARY OF THE INVENTION

The aim of the present invention is to provide connection of the armature lamella stack to the shaft which is improved in a vibration-damping manner.

The aim is met by a fastening device for an armature lamella stack of a DC motor, which is characterized in that the fastening device is disposed between the armature lamella stack and a shaft of the DC motor and is designed as a torsionally soft connection of said armature lamella stack to the shaft.

By means of the inventive, torsionally soft connection of the armature lamella stack to the shaft, a decoupling and a damping effect can be advantageously achieved. As a result, an acoustic decoupling between the armature lamella stack and a ventilating fan which is connected to the shaft and driven by the DC motor can be advantageously achieved. By means of the fastening device according to the invention, a natural frequency of the armature lamella stack of the DC motor is set lower than a natural frequency of the ventilating fan. Interfering acoustic resonances between the aforementioned elements are thus advantageously prevented.

One embodiment of the inventive fastening device is characterized in that the fastening device is formed from plastic. Due to the fact that plastic is substantially softer (approximately by a factor of 30) and damps to a greater degree than the steel of the armature lamella or the shaft, a decoupling or damping effect can be advantageously achieved between the two elements.

One embodiment of the fastening device is characterized by the fact that radial webs are formed between a first section disposed on the shaft and a second section of the fastening device spaced apart radially from said first section. In this manner, a spring element is formed which can dampen movements or, respectively, forces of the armature lamella stack that are introduced from the outside. This advantageously results in elements which are easy to produce and with which a spring effect can be precisely dimensioned.

In a further embodiment, the fastening device is integrally formed with a plastic part of the armature insulation of the DC motor.

One embodiment of the fastening device according to the invention is characterized by the fact that the webs are at least partially disposed in the axial direction between the first and the second section. A dimensioning option for the spring stiffness of the torsional springs advantageously ensues from such a disposal of the webs.

One embodiment of the invention is characterized by the fact that the webs are embodied as fan blades. Warm air can be easily led away with the fan blades, whereby an improved interior ventilation of the motor results.

Provision is made in a modification to the invention for the fastening device to be a rubber-to-metal element. In so doing, a cost effective standardized component having good damping properties can be used.

One embodiment of the fastening device according to the invention is characterized by the fact that metal elements of the rubber-to-metal element have a cylindrical form and comprise radial formations which are disposed on the metal elements so as in each case to be aligned relative to one another and offset. By means of the formations, shear forces on the rubber element disposed between the metal elements can advantageously be prevented in the circumferential direction.

One embodiment of the fastening device is characterized by the fact that said fastening device is integrally formed with a plastic part of a commutator of the DC motor. As a result, the commutator of the DC motor can also advantageously profit from the inventive decoupling effect.

A further embodiment of the fastening device is characterized by the fact that said fastening device comprises a collar on which the armature lamella stack is fastened. A fastening option which is simple to produce is thereby provided for the defined fastening of the armature lamella stack to the fastening device.

Embodiments of the fastening device are characterized by the fact that the fastening device is partially spaced apart from the shaft in the axial direction in a radially encircling manner, wherein a connection of the fastening device to the shaft is disposed in the region of the armature lamella stack or in the region of the commutator as viewed in the axial direction. In the variant mentioned first, one section comprising the commutator is thereby located at a free end of the fastening device, whereby the commutator can take part in the oscillation of the armature via the connection of the fastening device. In this manner, a relative movement between commutator hook and winding is prevented to the greatest extent and thus advantageously relieves the stress on a commutator weld.

The second variant having the free end of the fastening device in the region of the armature lamella stack has the consequence that a free torsional length of the fastening device can be enlarged and thus oscillations between the free end and the shaft attachment in the region of the commutator can be reduced. The commutator can take part in small portions of the oscillation, which are still present in this region of the fastening device. It is also advantageous in this case that the commutator weld is not stressed.

A further embodiment of the invention is characterized by the fact that a connecting element for connecting the fastening device to the shaft is formed as a metal ring. In this way, a cost effective, alternative fixing option of the fastening device to the shaft is provided.

A further embodiment of the fastening device is characterized by the fact that the fastening device is embodied as two parts, wherein the armature lamella stack is fastened to the shaft by means of a first part, and the commutator is fastened to the armature lamella stack by means of a second part. In this manner, the commutator can also be included in the decoupling effect of the fastening device because essentially any relative movements between the commutator and the armature lamella stack are no longer possible.

Embodiments of the fastening device are characterized by the fact that the commutator and the second part of said fastening device are connected to one another in a positive locking or force-fitting manner. As a result, a multiplicity of technically proven connecting options can be used, which all facilitate a good connection and a secure seating of the commutator at the second part of the fastening device.

According to a further aspect of the present invention, a DC motor is provided, comprising:
a fastening device for fastening an armature lamella stack of the DC motor to a shaft of said DC motor;

wherein the fastening device is disposed between the armature lamella stack and the shaft and is embodied as a torsionally soft connection of said armature lamella stack to said shaft.

It is considered to be an advantage of the invention that a transmission of oscillations of the armature lamella stack to a ventilating fan which is likewise fastened to the shaft is either reduced as much as possible or entirely prevented by means of the torsionally soft connection of the armature lamella stack to the shaft. In so doing, an acoustic oscillation resonance and consequently a noise level of the entire arrangement can be reduced. A user comfort of the ventilating fan (e.g. in the automotive field) can thus be significantly increased.

### BRIEF DESCRIPTION OF THE DRAWINGS

The invention is described below in detail comprising further features and advantages with the aid of a plurality of figures. All of the described or depicted features by themselves or in any desired combinations constitute the subject matter of the invention independently of the composition thereof in the patent claims or the back references thereof as well as independently of the formulation or depiction thereof in the detailed description or in the figures. The figures are for the most part intended to clarify the principles essential to the invention and are not necessarily depicted true to scale.

In the drawings:

FIG. 1 shows a first embodiment of the fastening device according to the invention;

FIG. 2 shows a further embodiment of the fastening device according to the invention;

FIG. 2a shows the embodiment of the inventive fastening device from FIG. 2 in cross-section;

FIG. 2b shows a further embodiment of the inventive fastening device in cross-section;

FIG. 3 shows a further embodiment of the inventive fastening device;

FIG. 3a shows a further embodiment of the inventive fastening device;

FIG. 3b shows a further embodiment of the inventive fastening device; and

FIG. 4 shows a further embodiment of the inventive fastening device.

### DETAILED DESCRIPTION

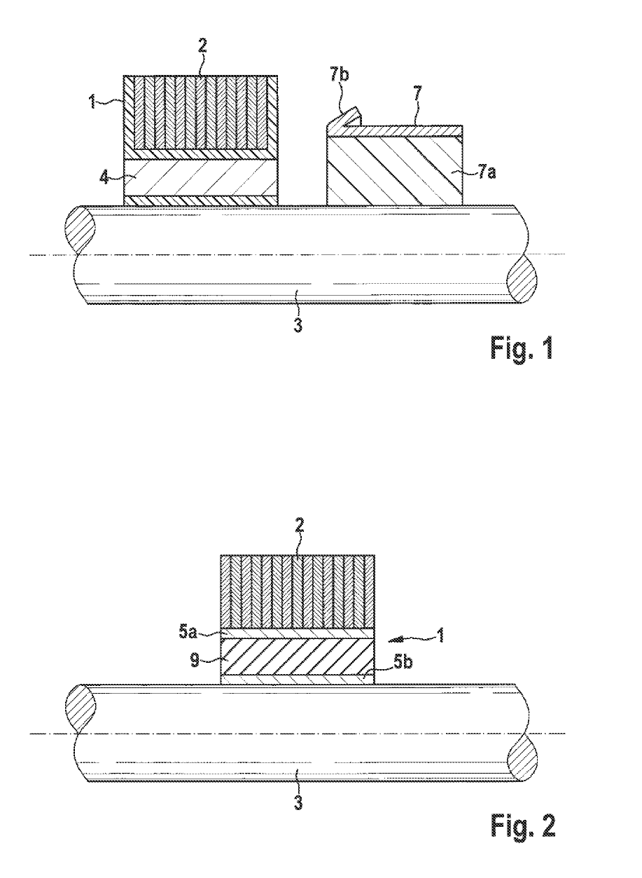

FIG. 1 shows a first embodiment of the fastening device according to the invention in a longitudinal section. By means of the fastening device 1, an armature lamella stack 2 typically formed from steel is connected as part of a rotor of a brush-commutated DC motor to a shaft 3 of the DC motor. The DC motor has a commutator 7 comprising a plurality of commutator lamellae, in the commutator hooks 7b of which insulated windings (not depicted) which are wound around the armature lamella stack 2 are hooked. The fastening device 1 is preferably formed from a plastic material and comprises two sections, a first section of said fastening device 1 being directly disposed on the shaft 3. A second section, in which the armature lamella stack 2 is arranged or, respectively, mounted, is disposed in a manner so as to be spaced apart from said first section both radially and circumferentially about the shaft 3. A torsionally soft connection of the armature lamella stack 2 to the shaft 3 is provided in this manner by means of the fastening device 1. This results in the two steel parts (armature lamella stack 2 and shaft 3) being decoupled in an oscillation-damping manner from one another. A ventilating fan (not depicted) which is likewise disposed on the shaft 3 (e.g. by means of an entraining element) and is driven by the motor, can thus not enter into a resonance superelevation with the armature lamella stack 2.

Radial webs, which are at least partially disposed in the axial direction of the shaft 3, are preferably formed between the first and the second section. The webs 4 can preferably be embodied as fan blades. This has the advantage that in addition to the decoupling or damping effect, a ventilation effect of the fastening device 1 is produced for the motor.

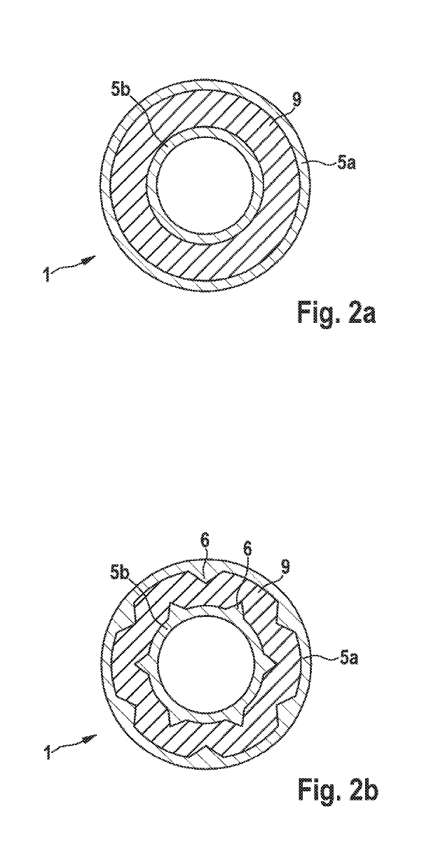

FIG. 2 shows a further embodiment of the fastening device according to the invention. In this variant, the fastening device 1 is embodied as a rubber-to-metal element which has a damping rubber element 9 between an outer and an inner metal element 5a, 5b. A decoupling of the armature lamella stack 2 from the shaft 3 can also be achieved in this manner.

FIG. 2a shows the rubber-to-metal element from FIG. 2 in a cross-sectional view with the rubber element 9 disposed between the cylindrically shaped metal elements 5a, 5b.

FIG. 2b shows a further embodiment of an inventive fastening device 1 in the form of a rubber-to-metal element. It can be seen that metallic formations 6, which are aligned relative to one another and are radially offset, are formed in each case on the outer metal element 5a and the inner metal element 5b. In so doing, a polygonal (zig-zag or meander) shape of the inner and outer ring is achieved. As a result, the rubber element 9 disposed between said rings is advantageously protected from shear stress because the regions of the rubber element 9 which are loaded in terms of forces are segmentally reduced by the formations 6.

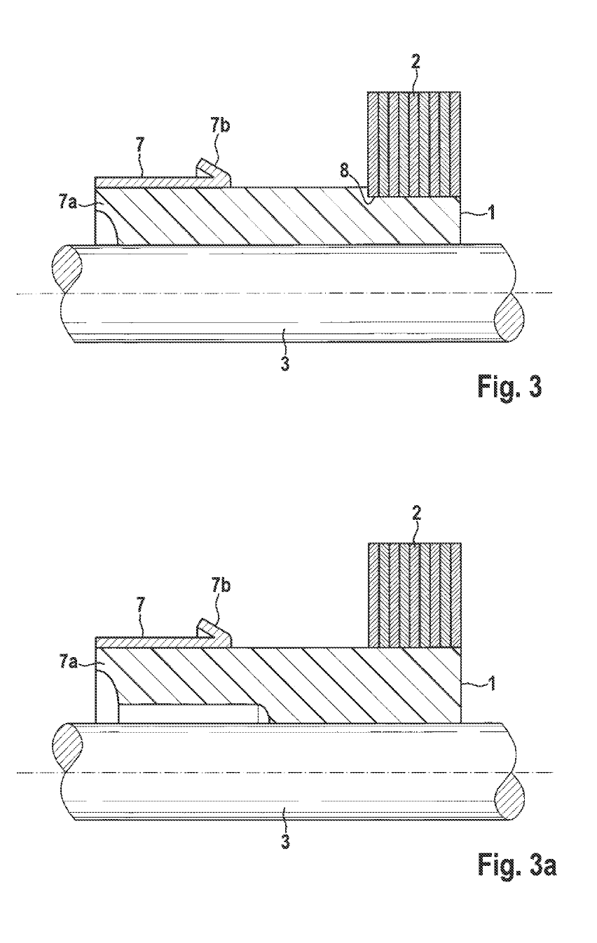

FIG. 3 shows a further embodiment of the fastening device according to the invention. It can be seen in this embodiment that said fastening device 1 is formed integrally with a plastic part 7a of the commutator 7. This results in the commutator 7 and the armature lamella stack being held by the same retaining element, whereby harmful relative movements between the winding fastened to the armature lamella stack 2 and the winding fastened to the commutator hook 7b are advantageously prevented in the long term, said windings being, e.g., enameled wire windings. As a result, a commutator weld by means of which the winding is welded to the commutator hook 7b is relieved of stress. In this way, a decoupling effect is then also achieved for the commutator 7. A collar 8 is preferably disposed in the fastening device 1, whereby a locally precise positioning of the armature lamella stack 2 on the fastening device 1 is supported.

A variant consisting of an overall arrangement of the fastening device 1 with the shaft 3, in which the shaft 3 has an evenly reduced diameter across the length of said shaft 3 in the region of the inventive fastening device 1, is not depicted in the figures. In this manner, a torsional stiffness of the shaft 3 is reduced, whereby an additional decoupling of the armature oscillations is brought about towards the output drive. Of course, other types of reduction of the diameter of the shaft 3 such as, for example, flattening or a knurling of the shaft, are also conceivable.

FIG. 3a shows a modification to the embodiment of the fastening device depicted in FIG. 3. In this case, a section comprising the commutator 7 is located spaced apart from the shaft 3, i.e. at a free end of the fastening device 1. As a result, the commutator can take part in an oscillation of the armature lamella stack 2 via the connection of the fastening device 1. A commutator weld is also advantageously relieved of stress in this instance because relative movements between the winding and hook of the commutator 7 are substantially prevented. By an appropriate dimensioning of the spacing of the fastening device 1 from the shaft 3, a damping behavior of said fastening device 1 can be dimensioned (for example by means of the finite element method FEM).

FIG. 3b shows a further modification to the embodiment of the fastening device from FIG. 3. In this case, a connecting section of the fastening device 1 to the shaft 3 is located, as viewed in the axial direction, in the region of the commutator 7. A section comprising the armature lamella stack 2 is thereby located at a free end of the fastening device 1, said free end being spaced apart from the shaft 3. In so doing, oscillations between said free end and the connecting section of said fastening device 1 are damped. The commutator 7 then only takes part in the portion of the oscillation which still occurs in said axial section of said fastening device. A commutator weld is also advantageously relieved of stress in this instance.

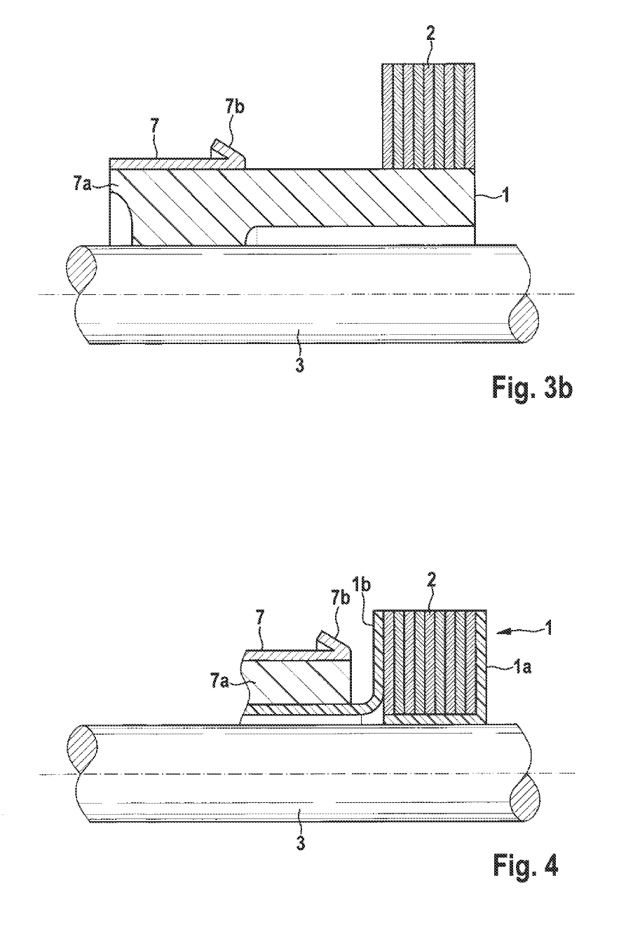

FIG. 4 shows a further embodiment of the fastening device according to the invention. In this case, the fastening device 1 is configured in two parts, wherein a first part 1a is provided for fastening the armature lamella stack 2 to the shaft 3. A second part 1b serves to fasten the commutator 7 to the armature lamella stack 2. A relative movement between the winding (not depicted) and the armature lamella stack 2 is also prevented in this way, whereby a decoupling effect can also be utilized for the commutator 7.

A plurality of options is conceivable for fastening the plastic part 7a of the commutator 7 to the second part 1b of the fastening device 1. It is, for example, possible to provide a force-fitting connection (e.g. press fit) between the aforementioned parts. Furthermore, a positive-locking connection (e.g. by means of serration) is also conceivable between said aforementioned parts. A stable seating of the plastic part 7a of the commutator 7 on the armature lamella stack 2 is supported for the long term by the previously stated connection options.

In summary, a decoupled and damped connection of an armature lamella stack to a shaft of a DC motor is provided by the present invention. By means of a damping plastic element, a noise pathway from the oscillating armature lamella stack to the shaft is interrupted. A stiffness from the armature lamella stack to the shaft is reduced by means of the torsionally soft connection of the armature lamella stack to the shaft which results by means of the plastic element. A torsional frequency is thereby low tuned and is smaller than the natural frequency of a ventilating fan which is substantially rigidly connected to the shaft. By “pulling apart” the two natural frequencies, resonances can therefore be effectively suppressed.

Due to the fact that plastic is a soft material, a deformation of the fastening device can decrease towards the center of the shaft, whereby the excitatory energy of the driven armature lamella stack is “damped away” to a certain extent.

The torsional spring can be advantageously dimensioned in the spring stiffness thereof by means of the previously described dimensioning options, whereby the natural frequency of the system, with respect to the frequency of the force which is predetermined by the operating behavior of the motor, can be dimensioned. If said frequencies lie far enough apart from one another, an optimal effect of decoupling can be achieved.

The forces of the system capable of oscillating (armature lamella stack plus shaft plus ventilating fan) are therefore decoupled from one another. As a result, the external armature lamella stack and the external ventilating fan act like masses and the internal long shaft like a torsionable spring. According to the invention, a torsional stiffness of the entire system is made as low as possible in order to decouple the oscillations of the armature lamella stack and the ventilating fan from one another.

In a simple manner, the fastening device according to the invention can advantageously be produced as a complete assembly by means of a plastic encapsulation process of shaft and armature lamella stack, whereby a joining of the aforementioned prefabricated parts can be omitted.

A person skilled in the art will recognize that according to the inventive principle a multiplicity of embodiments of the inventive fastening device can be implemented. Said person skilled in the art will also take shapes and materials for the fastening device into consideration which have not been or have only partially been disclosed above without deviating from the quintessence of the invention. Said person skilled in the art will furthermore recognize that the inventive principle of a torsionally soft connection is not limited to a ventilating fan driven by a DC motor.

What is claimed is:

1. A fastening device (1) for an armature lamella stack (2) of a DC motor, characterized in that the fastening device (1) is disposed between the armature lamella stack (2) and a shaft (3) of the DC motor and is a torsionally soft connection of said armature lamella stack (2) to the shaft (3).

2. The fastening device according to claim 1, characterized in that the fastening device (1) is formed from plastic.

3. The fastening device according to claim 2, characterized in that the fastening device is integrally formed with a plastic part of the armature insulation of the DC motor.

4. The fastening device according to claim 1, characterized in that radial webs (4) are formed between a first section of the fastening device (1) arranged on the shaft (3) and a second section of said fastening device (1) which is radially spaced apart from the first section.

5. The fastening device according to claim 4, characterized in that the webs (4) are at least partially disposed in an axial direction between the first and the second section.

6. The fastening device according to claim 4, characterized in that the webs (4) are embodied as fan blades.

7. The fastening device according to claim 1, characterized in that the fastening device is a rubber-to-metal element.

8. The fastening device according to claim 7, characterized in that metal elements (5a, 5b) of the rubber-to-metal element have a cylindrical form and have radial formations (6) which are arranged in each case on the metal elements (5a, 5b) so as to be aligned relative to one another and offset.

9. The fastening device according to claim 1, characterized in that the fastening device is integrally formed with a plastic part of a commutator (7) of the DC motor.

10. The fastening device according to claim 9, characterized in that the fastening device has a collar (8) to which the armature lamella stack (2) is fastened.

11. The fastening device according to claim 9, characterized in that the fastening device is partially spaced apart from the shaft (3) in an axial direction in a radially encircling manner, wherein a connection of the fastening device (1) to the shaft (3) is disposed, as viewed in the axial direction, in the region of the armature lamella stack (2) or in the region of the commutator (7).

12. The fastening device according to claim 11, characterized in that a connecting element (9) for connecting the fastening device to the shaft (3) is embodied as a metal ring (10).

13. The fastening device according to claim 1, characterized in that the fastening device (1) is embodied as two parts, wherein the armature lamella stack (2) is fastened to the shaft (3) by means of a first part (1a), and the commutator (7) is fastened to the armature lamella stack (2) by means of a second part (1b).

14. The fastening device according to claim 13, characterized in that the commutator (7) and the second part (1b) of the fastening device are connected to one another in a positive-locking or force-fitting manner.

15. A DC motor, comprising:
a fastening device (1) for fastening an armature lamella stack (2) of the DC motor to a shaft (3) of the DC motor;
wherein the fastening device (1) is disposed between the armature lamella stack (2) and the shaft (3) and is a torsionally soft connection of said armature lamella stack (2) to said shaft (3).

16. The DC motor according to claim 15, characterized in that the fastening device (1) is formed from plastic.

17. The DC motor according to claim 16, characterized in that the fastening device is integrally formed with a plastic part of the armature insulation of the DC motor.

18. The DC motor according to claim 15, characterized in that radial webs (4) are formed between a first section of the fastening device (1) arranged on the shaft (3) and a second section of said fastening device (1) which is radially spaced apart from the first section.

19. The DC motor according to claim 18, characterized in that the webs (4) are at least partially disposed in an axial direction between the first and the second section.

20. The DC motor according to claim 18, characterized in that the webs (4) are embodied as fan blades.
